(19) United States
(12) Patent Application Publication
(10) Pub. No.: US 2026/0021623 A1
(43) Pub. Date: Jan. 22, 2026

(54) VACUUM ABSORBING, BLOW MOLDED, CONTAINER BASE

(71) Applicant: AMCOR RIGID PACKAGING USA, LLC, Ann Arbor, MI (US)

(72) Inventors: Lauren STRAPEC, Dexter, MI (US); Michael T. LANE, Brooklyn, MI (US); James STELZER, South Lyon, MI (US)

(21) Appl. No.: 18/875,542

(22) PCT Filed: Jun. 21, 2022
(86) PCT No.: PCT/US2022/034209

§ 371 Date: Dec. 16, 2024

(51) Int. Cl. B29C 49/42; B29C 49/12; B29C 49/64; B29L 31/00

(52) U.S. Cl. CPC B29C 49/4283; B29C 49/1212; B29C 49/6604; B29C 2049/6607; B29L 2031/7158

(57) ABSTRACT

A container blow molded from a polymeric material, which is configured to store a hot-fill product. A first wall extends from a standing ring to a diaphragm of a base. A first hinge is at a first interface between the first wall and the standing ring. A second hinge is at a second interface between a second wall and a third wall extending to a center portion. In response to a vacuum generated within the container as the hot-fill product cools subsequent to filling and capping the container, the base is configured to move inward from an as-blown configuration to an activated configuration to absorb the vacuum by flexing at the first hinge and the second hinge. In the activated configuration, the center portion, the second wall, the third wall, and the second hinge are closer to the finish than in the as blown configuration.

### FIELD

The present disclosure relates to a vacuum absorbing, blow molded base of a polymeric container.

### BACKGROUND

This section provides background information related to the present disclosure, which is not necessarily prior art.

As a result of environmental and other concerns, plastic containers, more specifically polyester, and even more specifically polyethylene terephthalate (PET) containers, are being used more than ever to package numerous commodities previously supplied in glass containers. Manufacturers and fillers, as well as consumers, have recognized that PET containers are lightweight, inexpensive, recyclable, and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and pc is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall. These containers are suitable for ambient or cold-filling applications.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-35%. These containers are suitable for hot-filled containers and higher temperature processing.

While current polymeric containers are suitable for their intended use, they are subject to improvement. For example, some containers/bases may stick to the mold during the molding process. The present disclosure advantageously includes an improved container base configuration and molding assembly that reduces the likelihood of the base sticking to the mold. Another advantage is improved container base performance for hot-filled products that create high vacuum within the container after the container is filled, capped, and allowed to cool. One skilled in the art will appreciate that the present disclosure provides numerous additional advantages and unexpected results as well.

### SUMMARY

This section provides a general summary of the disclosure, and is not a comprehensive disclosure of its full scope or all of its features.

The present disclosure includes a container blow molded from a polymeric material. The container is configured to store a hot-fill product therein. The container includes a finish defining an opening, a body, and a base. The base has a standing ring and a center portion. An axial center of the base extends through the center portion. A diaphragm of the base is between the standing ring and the center portion. A first wall extends from the standing ring to the diaphragm. A first hinge is at a first interface between the first wall and the standing ring. A second wall extends from the diaphragm towards the axial center of the base. A second hinge is at a second interface between the second wall and a third wall extending to the center portion. In response to a vacuum generated within the container as the hot-fill product cools subsequent to filling and capping the container, the base is configured to move inward from an as-blown configuration to an activated configuration to absorb the vacuum by flexing at the first hinge and the second hinge. In the activated configuration, the center portion, the second wall, the third wall, and the second hinge are closer to the finish than in the as blown configuration.

The present disclosure further includes an injection blow molding assembly configured to form a polymeric container. The injection blow molding assembly includes a body mold and a base mold. The base mold has a center cone, an outer flange, and a diaphragm forming portion between the outer flange and the center cone. A stretch rod is movable between a retracted position and an extended position. The stretch rod defines a plurality of cooling apertures through which air passes to cool a base of the polymeric container. In the retracted position the stretch rod is outside of the center cone and air passing through the cooling apertures is directed towards the outer flange, the diaphragm forming portion, and an outer surface of the center cone. In the extended position, the stretch rod is within the center cone and air passing through the cooling apertures is directed towards an inner surface of the center cone.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a side view of a container in accordance with the present disclosure;

FIG. 2 is a plan view of a base of the container of FIG. 1;

FIG. 3A is a cross-sectional view of the base of the container of FIG. 1 in an as-blown configuration;

FIG. 3B is a cross-sectional view of the base of the container of FIG. 1 in an activated configuration;

FIG. 4A is a cross-sectional view of an alternative base of the container of FIG. 1 in an as-blown configuration;

FIG. 4B is a cross-sectional view of the alternative base of FIG. 4A in an activated configuration;

FIG. 5 is a perspective view of an injection blow-molding assembly in accordance with the present disclosure for forming a container, such as a container of FIG. 1, the assembly including a base mold in a retracted position; and

FIG. 6 illustrates the assembly of FIG. 5 with the base mold in an extended position.

Corresponding reference numerals indicate corresponding parts throughout the several views of the drawings.

### DETAILED DESCRIPTION

Example embodiments will now be described more fully with reference to the accompanying drawings.

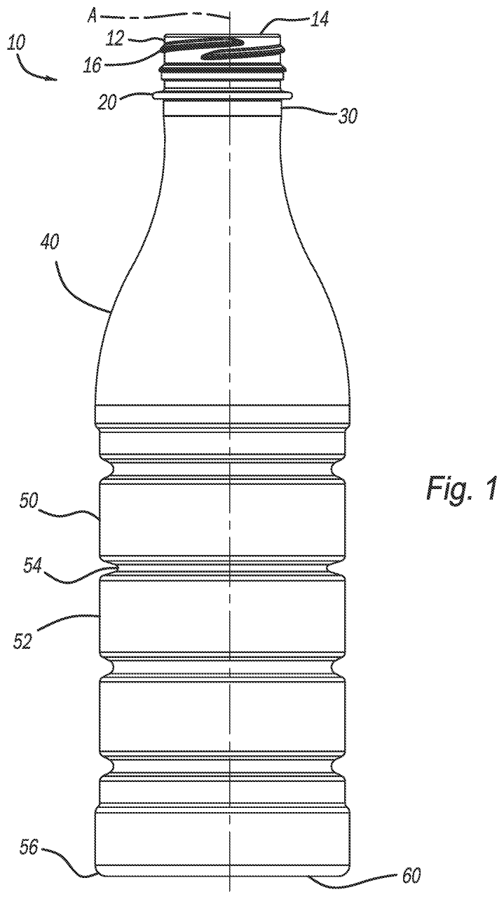

With initial reference to FIG. 1, an exemplary container in accordance with the present disclosure is illustrated at reference numeral 10. The container 10 may have the shape illustrated, or any other suitable shape. The container 10 may be of any suitable size, and may have any suitable capacity as well.

The container 10 may be made of any suitable material. For example, the container 10 may be made of polyethylene terephthalate (PET or PETE). The PET material may be entirely virgin PET, entirely recycled PET, or a blend of virgin PET and recycled PET. HS Ti818 offered by DAK Americas is an example of a suitable PET resin. PET is a clear, strong, and lightweight plastic that is widely used for packaging foods and beverages, convenience-sized soft drinks, juices, and water. It is also popular for packaging salad dressings, peanut butter, cooking oils, mouthwash, shampoo, soaps, cleaners, and the like. The basic building blocks of PET are ethylene glycol and terephthalic acid, which are combined to form a polymer chain. The resulting spaghetti-like strands of PET are extruded, quickly cooled, and cut into small pellets. The resin pellets are then heated to a molten liquid that can be easily extruded or molded into items of practically any shape.

PET is completely recyclable, and is the most recycled plastic in the U.S and worldwide. PET can be commercially recycled by washing and re-melting, or by chemically breaking it down to its component materials to make new PET resin. Almost every municipal recycling program in North America and Europe accepts PET containers. Products commonly made from recycled PET include new PET bottles and jars. Recycled PET is commonly referred to as rPET and PCR. PCR/PIR Recycled PET (rPET)—Post consumer recycled (PCR) resin is the recycled product of waste created by consumers. Post Industrial Regrind (PIR) is any closed-loop/recaptured scrap resin directly resulting from the manufacturing process, such as the scrap created by the manufacturing process of bottles and closures that is solely recaptured and reworked within the manufacturing plant, such as hot-runners, flash, moils, and tails from the molding or extruding process that has gone through at least one molding or extrusion process and is subsequently grounded and reintroduced back into the manufacturing process. Since PCR/PIR regrind material has gone through an initial heat and molding process, it cannot be considered “virgin” material. The physical, chemical and flow properties can differ slightly from virgin material. Therefore, PCR and PIR is not generally used exclusively to make new bottles or parts, but it is blended with virgin PET. Before PCR and PIR plastic is turned into resin, the materials are sent through a proprietary process and cleaning to produce plastic resin pellets. Verdeco food-grade rPET is an example of a suitable resin.

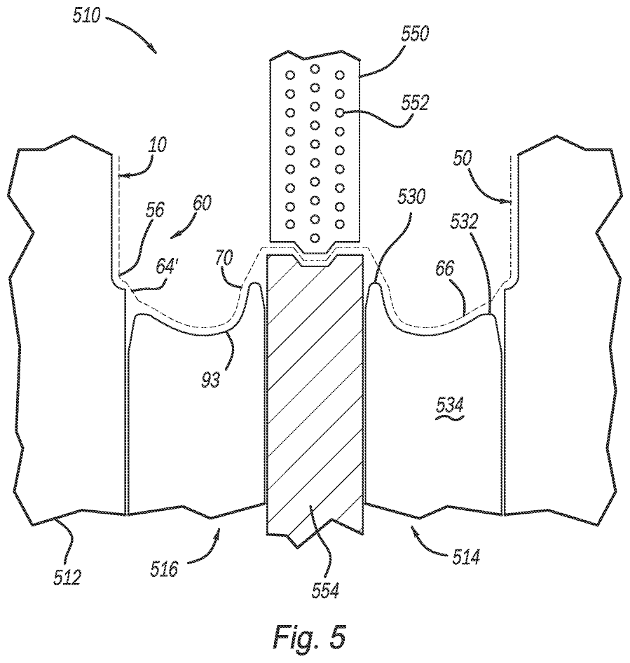

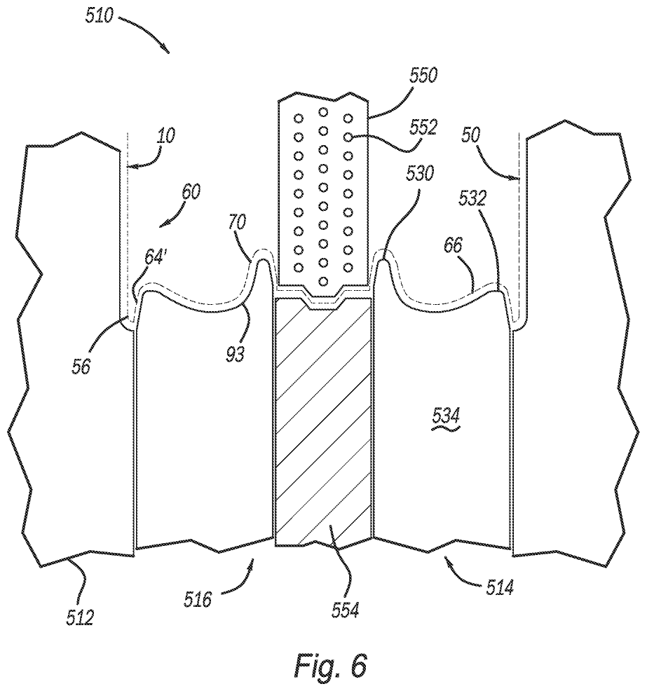

The container 10 is blow molded from a preform, which is injection molded. The preform is configured to form the container 10 by two-step stretch blow molding. The preform is optimized for the final blow molded container 10. To form the container 10 from the preform, the preform is heated and placed in a blow mold, where the preform is stretched lengthwise (axial stretch) to about twice its original length. Compressed air is then blown into the stretched preform to expand (radially stretch) the preform into a blow mold, such as the body mold 512 and the base mold 516 described herein and illustrated in FIGS. 5 and 6.

The container 10 is filled by hot filling, which is a process where a product is heated to a temperature of 194° F. or more to remove any harmful bacteria or microorganisms that might be with the product. Then, the hot fluid is filled into the container 10 and the container 10 is capped with any suitable closure. The container 10 may be filled with any suitable hot fill product, such as, but not limited to, the following: water, juice, sport drinks, or food products including pasta sauce and apple sauce.

The container 10 includes a finish 12, which defines an opening 14 through which product passes into and out of the container 10. At an exterior surface of the finish 12 are threads 16, which are configured to cooperation with corresponding threads of any suitable closure for capping and closing the opening 14. The threads 16 may be external threads as illustrated, internal threads, or any other suitable threads or locking structure for cooperating with a closure.

Below the threads 16 is a flange 20. Flange 20 is configured to support the preform in a blow molding machine. Below the flange 20 is a neck 30. Extending from the neck 30 is a shoulder 40. The shoulder 40 transitions to a body 50 of the container 10. The body 50 includes a plurality of side panels 52, which are separated by ribs 54. The side panels 52 and the ribs 54 are configured to absorb a vacuum formed within the container. At a lower part of the body 50 is a heel 56. The heel 56 transitions to a base 60 of the container 10.

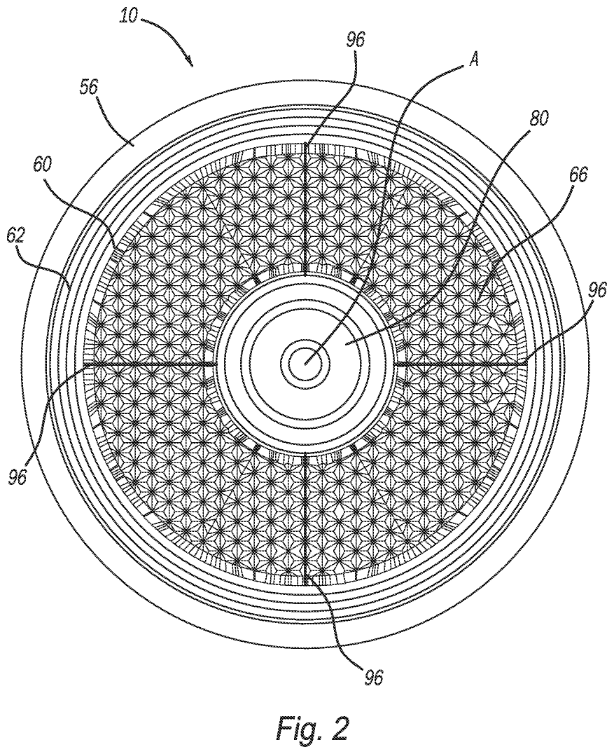

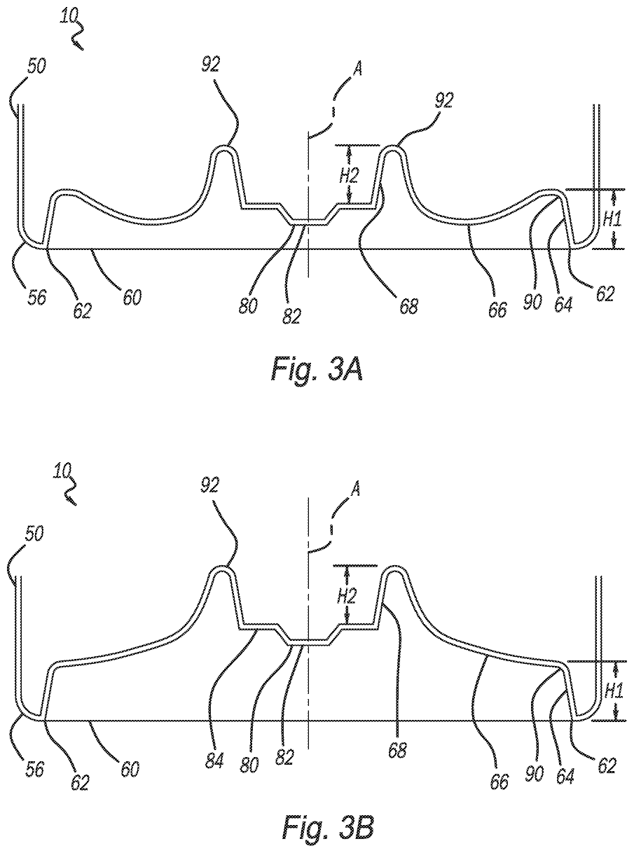

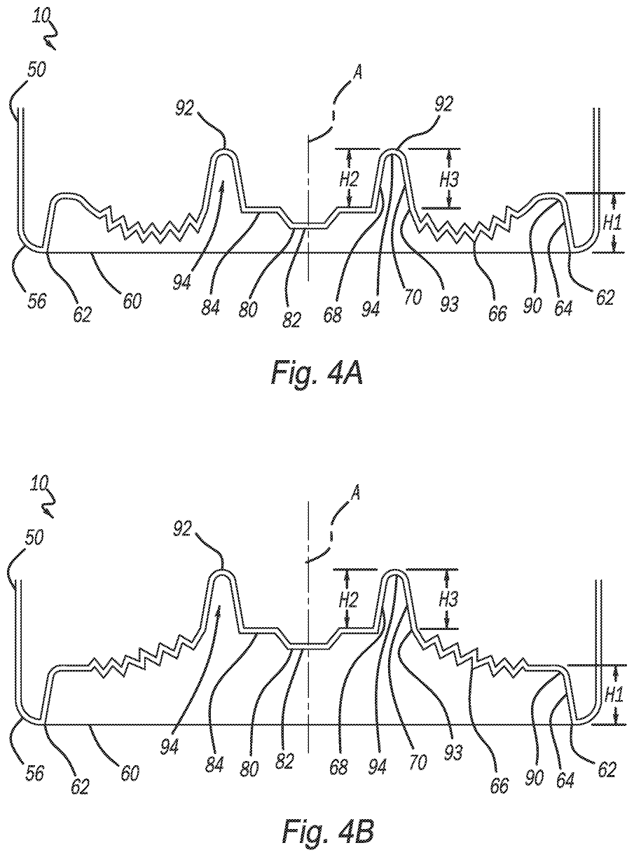

With continued reference to FIG. 1, and additional reference to FIGS. 2, 3A, 3B, 4A, and 4B, the base 60 will now be described in further detail. FIG. 3A illustrates the base 60 in an as-blown configuration. FIG. 3B illustrates the base 60 in an activated configuration. FIG. 4A illustrates an alternate configuration of the base 60 in an as-blown configuration. FIG. 4B illustrates the alternate configuration of the base 60 in an activated configuration. Differences between the base 60 of FIGS. 3A, 3B and the base 60 of FIGS. 4A, 4B are described herein.

In the example illustrated, the base 60 is round. A longitudinal axis A of the container 10 extends through an axial center of the base 60. The longitudinal axis A also extends through an axial center of the finish 12, the neck 30, the shoulder 40, and the body 50.

The base 60 includes a standing ring 62. The standing ring 62 can be generally smooth and without any interruptions, or can have interruptions such as, but not limited to, ribs or straps. The standing ring 62 is configured to support the container 10 upright when seated on a planar surface.

Extending inward from the standing ring 62, in the direction of the finish 12, is a first wall 64 of the base 60. The first wall 64 is generally annular. As the first wall 64 extends away from the standing ring, the first wall 64 is angled inward towards the longitudinal axis A.

The first wall 64 transitions to a diaphragm 66 of the base 60. The diaphragm 66 is relatively more flexible than surrounding portions of the base 60, which allows the base 60 to move inward from the as-blown configuration of FIGS. 3A and 4A to the activated configuration of FIGS. 3B and 4B to absorb vacuum within the container 10 generated as the hot-fill product is cooled subsequent to capping the container 10. The diaphragm 66 extends from the first wall 64 inward in the direction of the longitudinal axis A to a second wall 68. The second wall 68 generally extends from the center portion 80 in the direction of the finish 12. As the second wall 68 extends from the center portion 80, the second wall 68 is angled away from the longitudinal axis A.

The base 60 may further include a third wall 70 (FIGS. 4A, 4B), located between the second wall 68 and the diaphragm 66. The third wall 70 extends in a direction away from the finish 12. The third wall 70 is opposite to the second wall 68. The first wall 64, the second wall 68, and the third wall 70 are circular. The second wall 68 and the third wall 70 define a groove 94 therebetween.

At an axial center of the base 60 is a center portion 80. The longitudinal axis A extends through the axial center of the center portion 80, which may include a dimple 82 protruding outward from an inner portion 84 of the center portion 80. The center portion 80 and the diaphragm 66 are generally seated in a common plane. The center portion 80 and the second wall 68 provide the base 60 with a rigid cone structure.

A first hinge 90 of the base 60 is at a transition area between the first wall 64 and the diaphragm 66. A second hinge 92 of the base 60 is between the diaphragm 66 and the second wall 68. The diaphragm 66 is generally between the first hinge 90 and the second hinge 92. The first and second hinges 90 and 92 facilitate movement of the base 60 from the as-blown configuration of FIG. 3A to the activated configuration of FIG. 3B. As the base 60 moves from the as-blown configuration of FIG. 3A to the activated configuration of FIG. 3B, the radii of the first hinge 90 and the second hinge 92 increases.

The base 60 of FIGS. 4A and 4B further includes a third hinge 93 positioned between the third wall 70 and the diaphragm 66. The first, second, and third hinges 90, 92 and 93 facilitate movement of the base 60 from the as-blown configuration of FIG. 4A to the activated configuration of FIG. 4B. As the base 60 moves from the as-blown configuration of FIG. 4A to the activated configuration of FIG. 4B, the radii of the first hinge 90, the second hinge 92, and the third hinge 93 increases.

The diaphragm 66 generally “snaps” into the activated configuration of FIGS. 3B and 4B. With reference to FIG. 2, the diaphragm 66 forms four equidistant creases 96 when in the activated configuration. To further facilitate movement of the base 60, the diagram 66 may include dimples configured to facilitate flexing of the diaphragm 66. The dimples may be triangle-shaped, or have any other suitable shape to facilitate flexing of the diaphragm 66.

The first wall 64 extends from the standing ring 62 to a first height H1. The second wall 68 extends from the center portion 80 to a second height H2. The third wall 70 extends from the diaphragm 66 to a third height H3. The first height H1 of the first wall 64 is less than, or equal to, the second height H2 of the second wall 68. The third height H3 of the third wall 70 can be any suitable height.

With additional reference to FIGS. 5 and 6, an exemplary injection blow molding assembly for blow molding the container 10 from a preform is generally illustrated at reference numeral 510. The assembly 510 generally includes a body mold 512 and a base insert 514, which holds a base mold 516. The base mold 516 includes a center cone 530, an outer flange 532, and a diaphragm forming portion 534. The diaphragm forming portion 534 is between the center cone 530 and the outer flange 532. The base insert 514 is movable between a retracted down or neutral position (FIG. 5) and an extended up position (FIG. 6).

The preform is blown and stretched into the body mold 512 to form the body 50 of the container 10. The preform is blown and stretched into the base mold 516 to form the base 60 of the container 10. As the preform is blown against the base mold 516, the diaphragm forming portion 534 forms the diaphragm 66 of the container 10. The base insert 514 moves from the initial position of FIG. 5 to the extended position of FIG. 6, which results in the center cone 530 forming the groove 94 in the base 60, and the outer flange 532 forming the first hinge 90.

The injection blow molding assembly 510 further includes a stretch rod 550. The stretch rod 550 defines a plurality of cooling apertures 552. During the blow molding process, the stretch rod 550 is actuated into the body mold 512 and to a stationary base post 554 of the base mold 516 to stretch the preform into the body mold 512 and to the base mold 516. FIG. 5 illustrates the stretch rod 550 at a first extended position in which the cooling apertures 552 are outside of the center cone 530. In the first extended position of FIG. 5, cooling airflow passing through the cooling apertures 552 flows to the interior surface of the base 60 to cool the inverted first wall 64′, the third wall 70, the diaphragm 66, the third hinge 93 and the heel 56 of the base 60. In the second extended position of FIG. 6, the base insert 514 extends into the container 10 forming the first wall 64, and the second wall 68. In the second extended position of FIG. 6, cooling airflow passing through the cooling apertures 552 flows to the interior surface of the base 60 to cool the second wall 68, the first hinge 90, the second hinge 92, and the diaphragm 66 of the base 60. The injection blow molding assembly 510 advantageously provides improved post-mold cooling of the base 60, which reduces the possibility of the base 60 sticking to the base mold 516. The assembly 510 further provides improved base crystallinity and material distribution. Moving the base mold 516 to the extended position of FIG. 6 advantageously increases mechanical axial stretch induced crystallinity, combined with blown radial stretch induced crystallinity at an interior of the base 60, which results in increased crystallinity in the first wall 64, the second wall 68, and the third wall 70.

The present disclosure thus provides for the container 10 and the injection blow molding assembly 510, which do not require a blow mold process aid from overstroke or counter stretch during blow molding. Overstroke is a complex, moving mechanical activation unit and on a blow mold machine used to form deep base geometry. The present disclosure does not require overstroke due to the shallow design of the base 60, which saves on operational and tooling costs. One skilled in the art will appreciate that the present disclosure provides numerous additional advantages as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A container blow molded from a polymeric material, the container configured to store a hot-fill product therein, the container comprising:
a finish defining an opening;
a body; and
a base including:
a standing ring;
a center portion, an axial center of the base extends through the center portion;
a diaphragm between the standing ring and the center portion;
a first wall extending from the standing ring to the diaphragm, a first hinge is between the first wall and the diaphragm; and
a second wall extending from the center portion, a second hinge is between the second wall and the diaphragm;
wherein in response to a vacuum generated within the container as the hot-fill product cools subsequent to filling and capping the container, the base is configured to move inward from an as-blown configuration to an activated configuration to absorb the vacuum by flexing at the first hinge and the second hinge, in the activated configuration the center portion, the second wall, the diaphragm, and the second hinge are closer to the finish than in the as blown configuration.

2. The container of claim 1, further comprising third wall between the second hinge and the diaphragm.

3. The container of claim 2, further comprising a groove defined between the second wall and the third wall.

4. The container of claim 3, wherein the groove is defined at an outer surface of the base.

5. The container of claim 2, wherein a third hinge is between the third wall and the diaphragm.

6. The container of claim 1, wherein in response to the vacuum the diaphragm is configured to flex more than each one of the first wall, the second wall, and the center portion.

7. The container of claim 1, wherein the center portion and the second wall define a rigid cone.

8. The container of claim 1, wherein the first wall is less than, or equal in height with, the second wall.

9. The container of claim 1, wherein the diaphragm is between the first hinge and the second hinge.

10. The container of claim 5, wherein the diaphragm is between the first hinge and the third hinge.

11. The container of claim 1, wherein a first radii of the first hinge and a second radii of the second hinge both increase as the base moves inward from the as blown configuration to the activated configuration.

12. The container of claim 5, wherein the radius of the third hinge increases as the base moves inward from the as blown configuration to the activated configuration.

13. The container of claim 1, wherein the diaphragm includes a plurality of dimples configured to facilitate flexing of the diaphragm and movement of the diaphragm from the as blow configuration to the activated configuration.

14. The container of claim 13, wherein the dimples are triangle-shaped.

15. The container of claim 1, wherein in the activated configuration the diaphragm forms four creases spaced apart equidistant from each other.

16. An injection blow molding assembly configured to form a polymeric container, the injection blow molding assembly comprising:
a body mold;
a base insert including a base mold having a center cone, an outer flange, and a diaphragm forming portion between the outer flange and the center cone; and
a stretch rod movable between a retracted position and an extended position, the stretch rod defining a plurality of cooling apertures through which air passes to cool a base of the polymeric container;
wherein when the base insert is in the retracted position the stretch rod is outside of the center cone and air passing through the cooling apertures is directed towards the outer flange, the diaphragm forming portion, and an outer surface of the center cone; and
wherein in the extended position the stretch rod is within the center cone and air passing through the cooling apertures is directed towards an inner surface of the center cone.

17. The injection blow molding assembly of claim 16, wherein the base insert and the base mold are movable towards and away from the body mold.

18. The injection blow molding assembly of claim 16, wherein the center cone defines a receptacle configured to receive a distal end of the stretch rod therein.

19. The injection blow molding assembly of claim 16, wherein the base mold is configured to form a base of the polymeric container, the base including the following:
a standing ring;
a center portion, an axial center of the base extends through the center portion;
a diaphragm between the standing ring and the center portion;
a first wall extending from the standing ring to the diaphragm, a first hinge between the first wall and the diaphragm; and
a second wall extending from the center portion away from the axial center of the base, a second hinge between the second wall and the diaphragm;
wherein in response to a vacuum generated within the container as the hot-fill product cools subsequent to filling and capping the container, the base is configured to move inward from an as-blown configuration to an activated configuration to absorb the vacuum by flexing at the first hinge and the second hinge, and the diaphragm, in the activated configuration the center portion, the second wall, the second hinge, and the diaphragm are closer to the finish than in the as blown configuration.
